(19) United States
(12) Patent Application Publication
(10) Pub. No.: US 2019/0240916 A1
(43) Pub. Date: Aug. 8, 2019

(54) COMPONENT PRODUCED BY ADDITIVE MANUFACTURING, HAVING A SUPPORT STRUCTURE

(71) Applicant: FIT AG, LUPBURG (DE)

(72) Inventor: ALEXANDER BONKE, PARSBERG (DE)

(21) Appl. No.: 16/329,844

(22) PCT Filed: Aug. 21, 2017
(86) PCT No.: PCT/EP2017/001000

§ 371 Date: Mar. 1, 2019

(30) Foreign Application Priority Data
Sep. 1, 2016 (DE) 10 2016 116 372.4

(51) Int. Cl. B29C 64/40; B22F 3/105

(52) U.S. Cl. CPC B29C 64/40; B33Y 10/00; B22F 3/1055

(57) ABSTRACT

A method for removing a support structure of a component produced by additive manufacturing is made possible, in a particularly simple manner, by repeatedly deflecting the free end of the support structure, by impingement of a bending moment, out of an initial position into a deflected position in such a way that the support structure experiences work hardening due to plastic deformation at a defined point, in particular at its fixed end, until the support structure breaks at that point upon a further deflection. A component produced by additive manufacturing and a bending apparatus for removing a support structure are also provided.

The invention relates to a component produced by additive manufacturing, having a support structure. The method furthermore relates to a method for building a support structure and to a method for removing a support structure. The method also relates to a bending apparatus for removing a support structure.

“Additive manufacturing” is understood in particular as the layered building of three-dimensional objects using a digital computer model, in particular by selective solidification of a build material applied in layers. The build material used for this can be present, for example, in powder form. Examples of such manufacturing methods are laser sintering, mask sintering, etc.

A number of additive manufacturing methods require support structures. The support structures as a rule are connected on the one hand to the component and on the other hand to the build platform, or else they attach at both ends to the component, for example in the interior of the component. These support structures serve in particular to brace components or component portions. They can prevent components from sinking in the build space or prevent distortion of the components before they have reached their final strength. In other words, the support structures prevent loss of the dimensional stability of a component, or prevent deviations in shape. Heat can furthermore, if desired, be discharged to the build platform via a suitable support structure.

The support structures must be removed after the build process has ended and the component is complete.

It is known to manufacture support structures using different methods and/or from different materials than the component itself. In such cases the support material has a different physical or chemical property than the build material so that it can more effectively be removed after the manufacturing process ends. A support material that has a lower melting point than the build material is often provided in such cases, so that the support structures can be detached from the component in an oven or in a warm solvent bath. The use of water-soluble support materials is also known. Removal of the support structures in such cases is comparatively simple and requires little effort.

In many cases, however, the support structures are manufactured in the course of the building of the component using the same additive manufacturing method, and from the same material, as the component itself. The support elements in this context are usually ones that are connected to one another with or without a surrounding frame structure. These support elements as a rule are connected to the component via preset breaking points directly below the component. In order to remove such structures from the component after the manufacturing process ends, as a rule a mechanical post-processing occurs in which the support structures are broken off or out using tools, for example a chisel, saw, pliers, etc. In other words, rigid, inflexible support structures of this kind are usually removed by the fact that forcible breaks, caused by pulling, tearing, or similar force impingements on the support elements, are generated at the preset breaking points. The forces required for this are comparatively large, so that damage to the component surface often occurs in conjunction with the removal of such support structures.

An object of the present invention is to make possible removal, in a particularly simple manner, of a support structure for a component produced by additive manufacturing. This object is achieved by a method according to claim 1, a method according to claim 2, a component according to claim 3, and a bending apparatus according to claim 10.

The method according to the present invention for removing a support structure of a component produced by additive manufacturing, the support structure comprising a free end and a fixed end connected to the component, is notable for the fact that the free end of the support structure is repeatedly deflected, by impingement of a bending moment, out of an initial position into a deflected position in such a way that the support structure experiences work hardening due to plastic deformation at a defined point, until the support structure breaks at that point upon a further deflection (claim 1).

The method according to the present invention for building a support structure of a component produced by additive manufacturing, the support structure being built in such a way that on the one hand it comprises a fixed end connected to the component, and that on the other hand it comprises a free end or that such a free end can be produced after the support structure is built, is notable for the fact that the support structure is built in such a way that the free end of the support structure is repeatedly deflectable, by impingement of a bending moment, out of an initial position into a deflected position in such a way that the support structure experiences work hardening due to plastic deformation at a defined point, until the support structure breaks at that point upon a further deflection (claim 2).

The component according to the present invention produced by additive manufacturing, having a support structure that comprises a free end and a fixed end connected to the component, is notable for the fact that the free end of the support structure is repeatedly deflectable, by impingement of a bending moment, out of an initial position into a deflected position in such a way that the support structure experiences work hardening due to plastic deformation at a defined point, until the support structure breaks at that point upon a further deflection (claim 3).

The bending apparatus according to the present invention for removing a support structure of a component produced by additive manufacturing, the support structure comprising a free end and a fixed end connected to the component, is notable for the fact that the free end of the support structure is to be repeatedly deflected, by impingement of a bending moment, out of an initial position into a deflected position in such a way that the support structure experiences work hardening due to plastic deformation at a defined point, until the support structure breaks at that point upon a further deflection (claim 10).

Advantageous embodiments of the invention are described in the dependent claims. The advantages and embodiments explained below in conjunction with the methods also apply mutatis mutandis to the component according to the present invention and to the bending apparatus, and vice versa.

A fundamental idea of the invention is to provide a support structure in such a way that it is flexible, and thus deflectable (bendable), in at least one spatial direction. This is achieved preferably by way of a suitable geometric shape for the support structure, in conjunction with a suitable attachment of the support structure to the component. Detachment of the support from the component is then no longer accomplished by applying large forces in a more or less undirected manner. Instead, a free end of the support structure is repeatedly deflected in the one spatial direction so that the support structure becomes plastically deformed (extension/compression) at a defined point, and work hardening thereby occurs there. In other words, a few deflection motions of the free end of the support structure produce a change in the material property of the support structure at that point, until the deformability (ductility) of the support structure in that region becomes sufficiently decreased that upon a further (repeated) deflection, i.e. upon another impingement of the bending moment, it breaks.

In a preferred embodiment, the support structure is plastically deformed not at an arbitrary point but instead (at least) at its fixed end located oppositely from the free end, in particular in the connecting region of the support structure with the component, so that work hardening occurs there (claim 4). The break thus occurs at the fixed end of the support structure, so that advantageously the entire support structure is removed from the component.

This deliberate breakage of the fixed end, provoked by work hardening, is effected preferably in a region of preset breaking points by way of which, in an embodiment of the invention, the fixed end of the support structure is attached to the component (claim 5). The preset breaking points can be embodied in such a way that no residues remain on the component during removal of the support structure.

In an embodiment of the invention, the deflectability (bendability) of the support structure is directionally dependent (claim 6), that directional dependence being brought about by the configuration of the support structure (geometry, conformation, etc.) and/or by the configuration of the connecting region, i.e. the manner in which the fixed end of the support structure is connected to the component. This means on the one hand that an absence of deflectability in one or several directions can be utilized in order to guarantee the necessary stability during the building process despite the deflectability of the support structure. In a powder-based manufacturing method the support structure can thus, in particular, be oriented with reference to the scraper direction. On the other hand, the deflectability in a specific direction is utilized in order to furnish preset breaking points oriented correspondingly thereto. In other words, the preset breaking points can be adapted to the deflection direction (or vice versa).

In an embodiment of the invention, the free end of the support structure is deflectable in a defined spatial direction (claim 7). An embodiment of the invention in which the free end of the support structure is deflectable exclusively in a single defined spatial direction has provided to be particularly advantageous for simple removal of the support structure.

In an embodiment of the invention, the length of the support structure is considerably greater than its height and width (claim 8). Elongated or extended support structures of this kind are, in particular, walls, beams, bars, or the like. The support structure is deflected preferably by gripping at the free end of the support structure in order to achieve a particularly large bending moment.

In an embodiment of the invention, the support structure encompasses a number of support walls spaced away from one another (claim 9). Appropriate support structures in this context are not only individual support walls not connected to one another. It is also conceivable for the support structure to encompass several support walls connected to one another. The connecting elements that connect the support walls to one another are preferably embodied in such a way that they do not impede the deflections. The connecting elements of the support walls can be embodied both in such a way that they co-execute the deflections of the support structure, and in such a way that they do not co-execute those deflections.

What is involved in principle is therefore still removal of the support structures by mechanical post-processing. With the aid of the invention, however, support structures can be removed in particularly simple and comparatively rapid fashion and with little effort, in particular without numerous individual steps. The support structures can be removed in a particularly reliable and defined manner by deliberately effected breaks at the fixed end of the support structures, i.e. at the end that is connected to the component, brought about by previously produced work hardening of that support structure region. The support structures can be removed completely and, above all, with no damage to the component. This represents a substantial advantage compared with known mechanical post-processing methods for removing support structures.

In order to bring about breakage of a support structure, all that is necessary according to the present invention is multiple deflection of the support structure, that deflection being possible with exertion of comparatively little force, in particular when the free end of the support structure is deflectable in a defined (“soft”) spatial direction (in the sense of a preferred direction). In the other spatial directions, conversely, the support structure can be embodied to be extremely stable. The support structure is preferably configured in such a way that a few repetitions of the deflection motion, i.e. a few impingements of the bending moment, for example four to eight deflections, are sufficient to bring about the necessary work hardening. For that purpose, the support structure that is used is preferably equipped with preset breaking points that weaken the material in a preferably narrowly delimited region, for example at points, lines, or surfaces, in such a way that a deflection (bending) of the support structure with a small number of repetitions is sufficient to exceed the elasticity limit of the material. The material weakening is preferably effected in this context by selection of a suitable geometric shape for defined support structure regions, for example by way of a material constriction. Also possible, however, is material weakening by way of a suitable locally limited modification of the material properties of the support structure, brought about e.g. by correspondingly adapted manufacture of the support structure or by a treatment of the support structure carried out after manufacture.

In addition, the support structures according to the present invention can be produced in material-saving fashion, especially when the support structures are embodied as individual support elements having no connecting elements. At the same time, the support structures can be built with particularly thin walls without detriment to their supporting function. As a result, they can also be built particularly quickly. If necessary, the support structures can comprise reinforcing elements for reinforcement, for example in the form of ribs or the like extending in a longitudinal direction, without thereby substantially impairing easily removability.

In summary, therefore, in a preferred embodiment of the invention, firstly the support structure according to the present invention, in contrast to the rigid structures known from the existing art, is deflectable from an initial position (zero position) into a deflected position. In addition, secondly the support structure is preferably directionally dependently deflectable. Furthermore, thirdly the support structure is deflectable in such a way that work hardening of the support structure material occurs in a region provided therefor, preferably in the region of the subsequent preset breaking points, in particular in a region of preset breaking points provided especially therefor, specifically and fourthly to the extent that the material property of the support structure material changes in that region in such a way that a few deflection motions out of the zero position already result in a break.

The invention is not limited to specific additive manufacturing methods, in particular not to specific methods or materials used to build the support structures. All that is essential here is that the support structure be embodied, in the region in which the break for removing the support structure is later to take place, i.e. in particular at the fixed end of the support structure which forms the connecting region to the component, in such a way that work hardening can occur there by mechanical impingement on the support structure, in particular as a result of a deflection of the free end of the support structure due to impingement of a bending moment.

Removal of the support structure is preferably effected exclusively as a result of the break brought about by deflection as described, i.e. in the absence of additional actions on the support structure, for example thermal, chemical, or other mechanical actions.

An exemplifying embodiment of the invention will be explained below in further detail with reference to the drawings, in which:

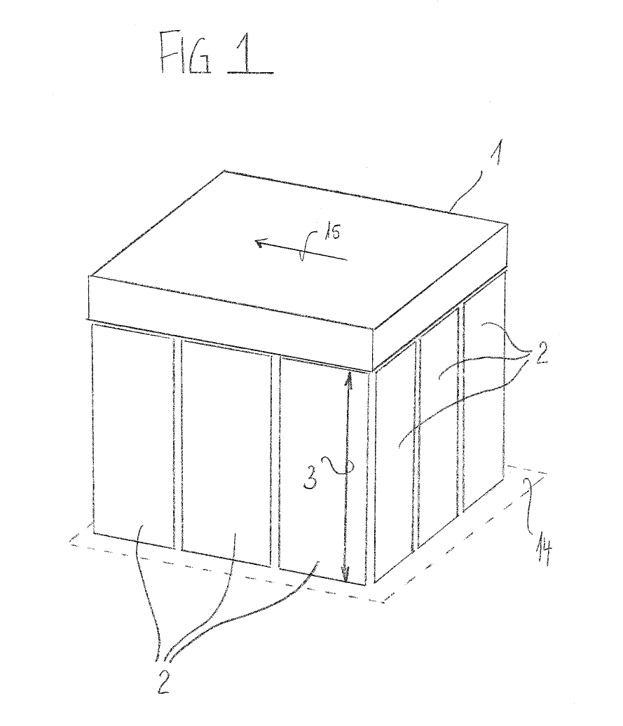

FIG. 1 depicts a component having several support walls;

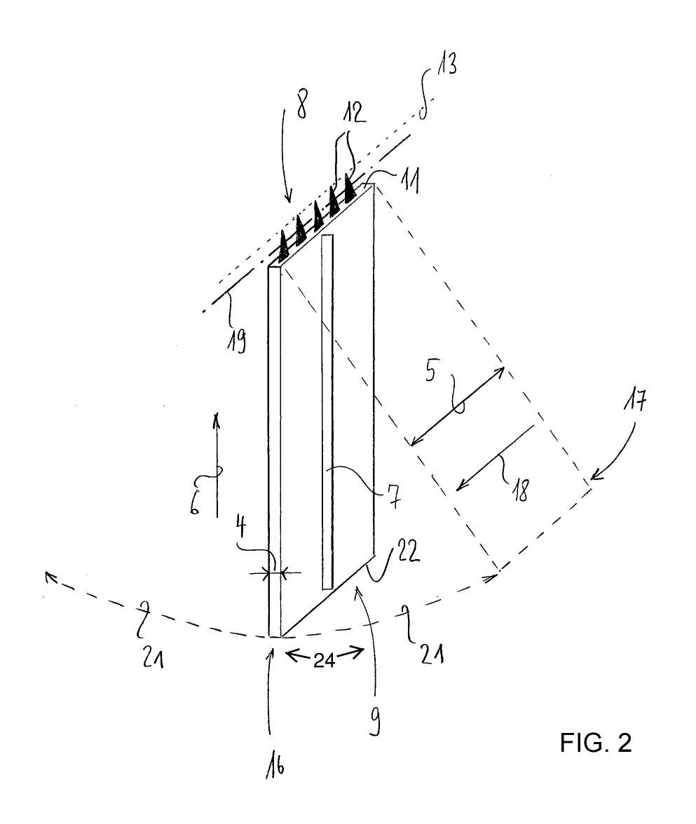

FIG. 2 depicts an individual support wall.

All the Figures show the invention not accurately to scale, merely schematically, and only with its essential constituents. Identical reference characters correspond to elements having an identical or comparable function.

During powder-based additive manufacturing of a component 1 (not described in further detail), the necessary support structures in the form of support walls 2 are simultaneously built using suitable computer-generated CAD data and under the usual control of one skilled in the art. A suitable powder, for example made of a metal material, serves as a build material for component 1 and for support walls 2.

Several support walls 2, which are spaced apart from one another and are not connected to one another, are provided in total for component 1. Length 3 of the individual support walls 2 is considerably greater than their height 4 and width 5. Support walls 2 are thin-walled, i.e. their height 4 is considerably less than their width 5. Longitudinal direction 6 of support walls 2 extends vertically. Optionally, support walls 2 comprise reinforcing elements in the form of support ribs 7, arranged centeredly and extending in longitudinal direction 6.

Each individual support wall 2 is connected at its fixed end 8, i.e. along its width 5, to component 1, forming a number of preset breaking points. In this region, more precisely on its upper narrow side 11, support wall 2 tapers into a plurality of teeth 12 and attaches to component 1 only in point fashion at the tooth tips. The connecting points are located on a line 13.

The oppositely located ends of support walls 2 are connected, for example, to a build platform 14 indicated in FIG. 1. After the completion of component 1, support walls 2 are detached from build platform 14 in its vicinity, thereby creating free ends 9, located oppositely from fixed ends 8, of support walls 2. Detachment is effected using a suitable detachment method, for example by cutting or milling.

The arrangement of support walls 2 with reference to component 1 and build platform 14 is directed principally toward enabling support walls 2 to perform their supporting function and their other functions. When support walls 2 whose design is optimized with regard to particularly low material consumption are used, in particular when particularly thin-walled support walls are used, the arrangement of support walls 2 can also be varied with regard to other parameters. In the context of the manufacturing method used, for example, the powdered build material is applied with the aid of a scraper (not illustrated). Support walls 2 can be arranged in such a way that they proceed in a scraper direction, i.e. parallel to motion direction 15 of the scraper. Because of their rigidity, if support walls 2 are equipped with support ribs 7 or other suitable reinforcing elements they can even withstand being wiped over by a scraper having a hard blade. In the case of a scraper having a soft rubber lip or the like, support walls 2 can also be arranged transversely to scraper direction 15.

The configuration and arrangement of support wall 2 and the configuration and arrangement of preset breaking points 12 are selected so that the deflectability of free end 9 of support wall 2 is directionally dependent, specifically in such a way that free end 9 of support wall 2 is deflectable in a single defined spatial direction (the “soft” direction), i.e. is deflectable repeatedly in that direction, by impingement of a bending moment, out of an initial position 16 into a deflected position 17, in such a way that support wall 2 experiences work hardening at its fixed end 8 as a result of plastic deformation, in particular longitudinal deformation, until the deformability (ductility) of fixed end 8 of support wall 2, in particular in the region of preset breaking points 12, decreases such that upon another deflection, i.e. upon another impingement of a bending moment, support wall 2 breaks at its fixed end 8, in particular in the region of preset breaking points 12.

In other words, teeth 12 form with their tips the preset breaking points of support wall 2, i.e. that region or those regions of the support structure which enable work hardening as a result of a material weakening, caused here by the conformation of the teeth. It is at the tooth tips that the elasticity limit of the material is first exceeded due to repeated bending of support wall 2, so that the desired work hardening occurs.

Instead of teeth 12 tapering to a point, other geometric shapes and/or regions having modified material properties are also possible as a way of furnishing suitable preset breaking points within the support structure.

In the example outlined here, support walls 2 can be deflected (bent) around a transverse axis 19 that is located in a transverse direction 18 of support wall 2, i.e. perpendicularly to the longitudinal center axis of support wall 2, said transverse axis 19 proceeding in the region of the preset breaking points (teeth) 12. Only a single spatial direction for the deflection exists, namely perpendicularly to that transverse axis 19. That deflection direction is indicated in FIG. 2 by arrows 21 to either side of initial position 16.

A suitable bending apparatus (not illustrated), with which support wall 2 has a defined bending moment impinged upon it at its free end 9, for example by way a force acting laterally or from below on the free end, in particular in the region or vicinity of its lower narrow side 22, is provided for this purpose. The bending apparatus is preferably embodied in such a way that it transfers the force onto support wall 2 in deflection direction 21. The bending apparatus can be driven manually or in motorized fashion.

Length 3 of support wall 2 corresponds substantially to the spacing between the effective line of the force (F) acting at free end 9, and fixed end 8 of support wall 2. In other words, that length (I) corresponds to the lever arm, so that the bending moment (M) is defined as: M=F×I. The support is thereby repeatedly deflected out of initial position 16 into deflected position 17 indicated in FIG. 2. Comparatively large bending moments can be generated using small lever forces. Advantageously, support wall 2 becomes deflected a comparatively long distance out of its zero position 16, so that particularly large elongation and compression processes occur in the interior of support wall 2, in particular in the connecting region with component 2, i.e. in the region of preset breaking points 12. After a few repetitions of the deflection operation, support walls 2 break off cleanly and in defined fashion at preset breaking points 12.

Because the deflections necessary for the removal of support walls 2 must occur in a particularly defined manner, in particular in the context of a directionally dependent deflectability of support walls 2, an automated method for removing support walls 2, preferably utilizing a motor-drivable bending apparatus, is particularly simple to implement.

If support walls 2 are mounted on a component 1 in a different way, in particular (as in the example depicted) in orientations differing from one another, the removal of support walls 2 is accomplished, if applicable sequentially, by corresponding deflection of free ends 9 of support walls 2 in different directions.

In an embodiment of the invention which is not illustrated, the support structures (here, support walls 2) are equipped with preset breaking points, for example in the form of suitable material constrictions, at specific, preferably regular, spacings along their longitudinal direction 6. In other words, preset breaking points can be provided not only directly on component 1 but also at a distance from component 1 farther along on support walls 2. Support walls 2 comprise, for example, several longitudinal portions separated from one another by preset breaking points. Complete removal of the support structures can thereby be effected, if necessary, portion by portion.

All features presented in the description, in the Claims that follow, and in the drawings can be essential to the invention both individually and in any combination with one another.

### LIST OF REFERENCE CHARACTERS

1 Component
2 Support wall
3 Length
4 Height
5 Width
6 Longitudinal direction
7 Support rib
8 Fixed end
9 Free end
10 (unassigned)
11 Upper narrow side
12 Tooth, preset breaking point
13 Point-type connecting line
14 Build platform
15 Motion direction of scraper
16 Initial position, zero position
17 Deflected position
18 Transverse direction
19 Transverse axis
20 (unassigned)
21 Deflection direction
22 Lower narrow side

1-10. (canceled)

11. A method for removing a support structure of a component produced by additive manufacturing, the method comprising the following steps:
providing a support structure having a fixed end connected to the component and having a free end; and
repeatedly deflecting the free end of the support structure by impingement of a bending moment from of an initial position into a deflected position causing the support structure to experience work hardening due to plastic deformation at a defined point, until the support structure breaks at the defined point upon a further deflection.

12. A method for building a support structure of a component produced by additive manufacturing, the method comprising the following steps:
building a support structure having a fixed end connected to the component and a free end or producing the free end after building the support structure; and
building the support structure to experience work hardening due to plastic deformation at a defined point due to repeatedly deflection of the free end of the support structure by impingement of a bending moment from an initial position into a deflected position until the support structure breaks at the defined point upon a further deflection.

13. A component produced by additive manufacturing, the component comprising:
a support structure having a fixed end connected to the component and a free end;
said free end of said support structure configured to experience work hardening due to plastic deformation at a defined point due to repeated deflection by impingement of a bending moment from an initial position into a deflected position until the support structure breaks at said defined point upon a further deflection.

14. The component according to claim 13, wherein said defined point of said support structure is at said fixed end.

15. The component according to claim 14, wherein said fixed end of said support structure is connected to the component by a plurality of preset breaking points.

16. The component according to claim 13, wherein at least one of said support structure or a connection of said fixed end of said support structure to the component causes said deflection of said free end of said support structure to be directionally dependent.

17. The component according to claim 13, wherein said free end of said support structure is configured to be deflected in a defined spatial direction.

18. The component according to claim 13, wherein said support structure has a height, a width and a length being greater than said height and said width.

19. The component according to claim 13, wherein said support structure is a support wall.

20. A bending apparatus for removing a support structure of a component produced by additive manufacturing, the support structure having a fixed end connected to the component and a free end, the bending apparatus comprising:
a device for repeatedly deflecting the free end of the support structure by impingement of a bending moment from an initial position into a deflected position causing the support structure to experience work hardening due to plastic deformation at a defined point, until the support structure breaks at the defined point upon a further deflection.
